(19) United States
(12) Patent Application Publication
(10) Pub. No.: US 2014/0207869 A1
(43) Pub. Date: Jul. 24, 2014

(54) METHOD AND APPARATUS FOR LAUNCHING AN APPLICATION IDENTIFIED BY A SENSOR

(71) Applicant: Teemu Ilmari Savolainen, Nokia (FI)

(72) Inventor: Teemu Ilmari Savolainen, Nokia (FI)

(73) Assignee: Nokia Corporation, Espoo (FI)

(21) Appl. No.: 14/241,070

(22) PCT Filed: Sep. 12, 2011
(86) PCT No.: PCT/IB2011/053988

§ 371 Date: Feb. 25, 2014

(51) Int. Cl. H04L 29/08

(52) U.S. Cl. CPC H04L 67/125
USPC 709/204

(57) ABSTRACT

A method, apparatus and computer program product are provided in order to facilitate the receipt and parsing of the data provided by a sensor with little, if any, user involvement. In the context of a method, a message, such as a measurement report, is received that includes or is associated with data provided by a sensor. The message includes an application identifier. The method also includes launching an application identified by the application identifier and then parsing the data provided by the sensor with the application.

### TECHNOLOGICAL FIELD

An example embodiment of the present invention relates generally to a method and apparatus for communicating with sensors via a network and, more particularly, to launching an application identified by a sensor so as to parse the data provided by the sensor.

### BACKGROUND

An increasing number of sensors are being deployed for capturing a wide variety of data. For example, sensors may include temperature sensors, charged coupled device (CCD) cameras, pressure sensors, movement sensors, heart rate sensors or the like. These sensors may be configured to communicate with a mobile terminal via a network. For example, the sensors may communicate with a mobile terminal via a home network, such as a wireless local area network (WLAN), with the sensors connected to the home network via WLAN, via a fixed Ethernet connection, via a proxy device or the like. Alternatively, a sensor may be connected directly to a mobile terminal, such as via a Bluetooth, Zigbee or other proximity-based connection.

In order to parse or otherwise process the data provided by a sensor, a mobile terminal may be executing an application that consumes the data provided by the sensor. In this regard, the application executed by the mobile terminal may have been previously installed upon the mobile terminal and is executing upon receipt of the data from the sensor. Alternatively, the mobile terminal may access a web browser in order to communicate with the sensor, such as a camera, in order to review the data collected by the sensor.

An increasing number of sensors, including a plurality of Internet Protocol version 6 (IPv6) enabled sensors, are being deployed. The IPv6 enabled sensors are often only capable of one-way communication, that is, the IPv6 enabled sensors may typically transmit data, but are often incapable of receiving information. As a result, the IPv6 enabled sensors may multicast data and other information over the network to which the IPv6 sensors are attached for receipt by mobile terminals and other devices that are in communication with the network. In this regard, the IPv6 sensors may multicast the data and other information with reference to unique media access control (MAC) and link-local IPv6 addresses with the link-local IPv6 addresses being generated from the MAC addresses. As such, the IPv6 sensors do not need to perform complex internet protocol (IP) address configuration with dynamic host configuration protocol (DHCP) or IPv6 Stateless Address Autoconfiguration procedures.

At least some of the techniques employed by mobile terminals to receive and parse the data provided by a sensor require user involvement and, in some instances, a substantial amount of user involvement. This user involvement may disadvantageously create a disincentive to utilize networked sensors. With the increase in the numbers and types of sensors, the utility of the sensors may be improved, but the disincentives attributable to user involvement in sensor integration and communication therewith may be exacerbated.

### BRIEF SUMMARY

A method, apparatus and computer program product are therefore provided in order to facilitate the receipt and parsing of the data provided by a sensor with little, if any, user involvement. As such, user devices, such as mobile terminals, may more readily utilize the data provided by sensors without requiring substantial user involvement, thereby at least partially removing an impediment to the adoption of networked sensors. As such, users may utilize their devices, such as mobile terminals, to make more frequent use of the data provided by sensors, thereby providing users with additional useful information.

In one embodiment, a method is provided that includes receiving a message provided by a sensor, such as measurement report including data. The message includes an application identifier. The method also includes launching an application identified by the application identifier and then parsing data provided by the sensor with the application.

The method of one embodiment may also download the application identified by the application identifier following receipt of the message. For example, the downloading of the application may include purchasing the application. The method of this embodiment may also cause a notification to be provided regarding the application identified by the application prior to downloading the application. In one embodiment, the method may also identify a plurality of applications identified by the application identifier and cause a listing of the plurality of applications to be provided in order to solicit user input regarding one or more of the plurality of applications to be launched. The method may also receive user input regarding whether to attach to a network via which the message from the sensor was received.

In another embodiment, an apparatus is provided that includes at least one processor and at least one memory storing computer program code with the at least one memory and stored computer program code being configured, with the at least one processor, to cause the apparatus to at least receive a message provided by a sensor, such as a measurement report including data. The message includes an application identifier. The at least one memory and stored computer program code are further configured, with the at least one processor, to cause the apparatus to launch an application identified by the application identifier and to parse data provided by the sensor with the application.

The at least one memory and stored computer program code may be further configured, with the at least one processor, to cause the apparatus of one embodiment to download the application identified by the application identifier following receipt of the message. For example, the downloading of the application may include purchasing the application. The at least one memory and stored computer program code may be further configured, with the at least one processor, to cause the apparatus of this embodiment to cause a notification to be provided regarding the application identified by the application prior to downloading the application. In one embodiment, the at least one memory and stored computer program code may be further configured, with the at least one processor, to cause the apparatus to also identify a plurality of applications identified by the application identifier and to cause a listing of the plurality of applications to be provided in order to solicit user input regarding one or more of the plurality of applications to be launched. The at least one memory and stored computer program code may also be configured, with the at least one processor, to cause the apparatus to receive user input regarding whether to attach to a network via which the message from the sensor was received.

In a further embodiment, a computer program product is provided that includes at least one non-transitory computer-readable storage medium having computer-readable program instructions stored therein with the computer-readable program instructions including program instructions configured to receive a message provided by a sensor, such as a measurement report including data. The measurement report includes an application identifier. The computer-readable program instructions also include program instructions configured to launch an application identified by the application identifier and program instructions configured to parse data provided by the sensor with the application.

The computer program product of one embodiment may also include program instructions configured to download the application identified by the application identifier following receipt of the message. For example, the downloading of the application may include purchasing the application. The computer program product of this embodiment may also include program instructions configured to cause a notification to be provided regarding the application identified by the application prior to downloading the application. In one embodiment, the computer program product may also include program instructions configured to identify a plurality of applications identified by the application identifier and to cause a listing of the plurality of applications to be provided in order to solicit user input regarding one or more of the plurality of applications to be launched. The computer program product may also include program instructions configured to receive user input regarding whether to attach to a network via which the message from the sensor was received.

In yet another embodiment, an apparatus is provided that includes means for receiving a message provided by a sensor, such as a measurement report including data. The message includes an application identifier. The apparatus also includes means for launching an application identified by the application identifier and means for parsing the data provided by the sensor with the application.

The apparatus of one embodiment may also include means for downloading the application identified by the application identifier following receipt of the message. For example, the downloading of the application may include purchasing the application. The apparatus of this embodiment may also include means for causing a notification to be provided regarding the application identified by the application prior to downloading the application. In one embodiment, the apparatus may also include means for identifying a plurality of applications identified by the application identifier and means for causing a listing of the plurality of applications to be provided in order to solicit user input regarding one or more of the plurality of applications to be launched. The apparatus may also include means for receiving user input regarding whether to attach to a network via which the message from the sensor was received.

### BRIEF DESCRIPTION OF THE DRAWINGS

Having thus described example embodiments of the present invention in general terms, reference will hereinafter be made to the accompanying drawings, which are not necessarily drawn to scale, and wherein:

FIG. 1 is a schematic presentation of a system including a user device and a plurality of sensors that may support an example embodiment of the present invention;

FIG. 2 is a block diagram of an apparatus that may be specifically configured in accordance with an example embodiment of the present invention;

FIG. 3 is a block diagram of a mobile terminal that may be specifically configured in accordance with an example embodiment to the present invention; and

FIG. 4 is a flowchart illustrating the operations performed according to an example embodiment to the present invention.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a physical storage medium (e.g., volatile or non-volatile memory device), can be differentiated from a “computer-readable transmission medium,” which refers to an electromagnetic signal.

As described below, a method, apparatus and computer program product are provided to facilitate communication between one or more sensors and a user device, such as a mobile terminal, via a network. In this regard, the method, apparatus and computer program product permit the user device to be configured to receive and parse the data provided by a sensor in a manner that requires little, if any, user involvement. In this regard, the sensor may identify one or more applications that are configured to parse the sensor data and, in an instance in which the application(s) identified by the sensor are not installed on the user device, the user device may download and launch the application(s) identified by the sensor without substantial user involvement so as to thereafter consume the sensor data.

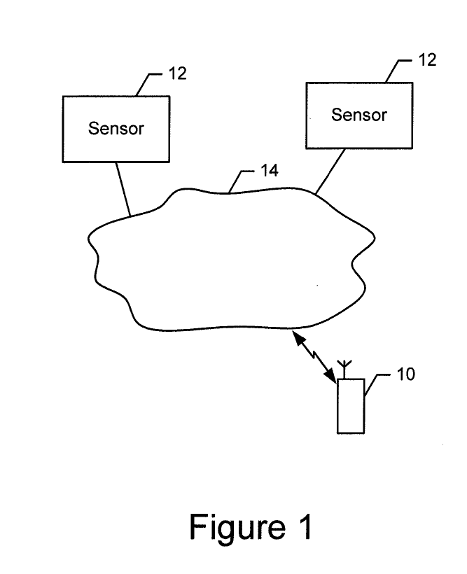

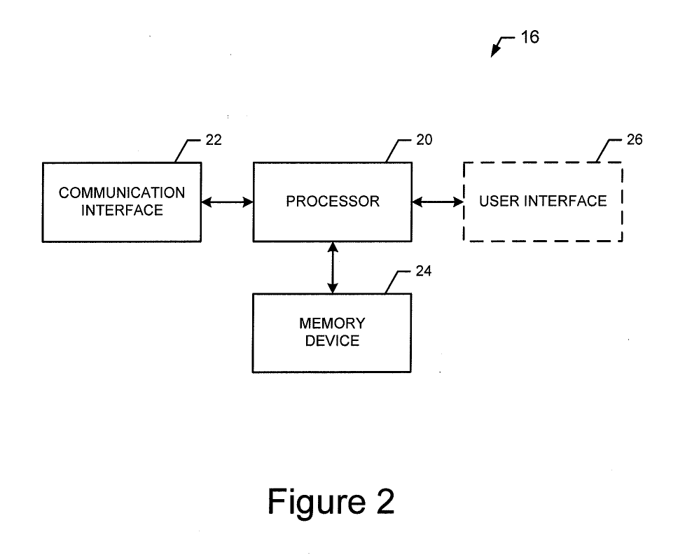

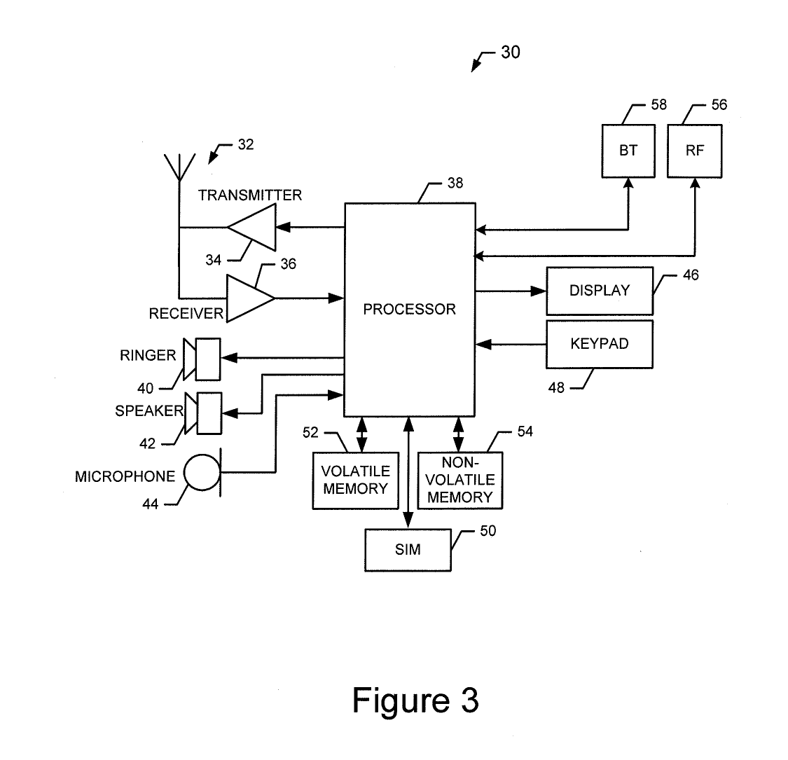

As noted above, the sensor(s) and the user device may communicate via a network such as shown, for example, in FIG. 1. In this regard, the system may include a user device 10 and one or more sensors 12 that are configured to communicate over a network 14. The system may include various types of sensors 12 including, for example, temperature sensors, charged coupled device (CCD) cameras, pressure sensors, movement sensors, heart rate sensors or the like. As shown in FIG. 1, the sensors 12 may be configured to communicate with the user device 10 via a network 14. For example, the sensors 12 may communicate with the user device 10 via a home network, such as a WLAN, with the sensors connected to the home network via WLAN, via a fixed Ethernet connection, via a proxy device or the like. Alternatively, a sensor 12 may be connected directly to the user device 10, such as via a Bluetooth, Zigbee or other proximity-based connection. The user device 10 may be any device that is configured to receive sensor data, such as for storage, processing, display or the like. For example, the user device 10 may consist of or include an apparatus 16, such as shown in FIG. 2, that is configured in the manner described below and, in one embodiment, may be a mobile terminal 30, such as shown in FIG. 3.

By way of example, an apparatus 16 for receiving sensor data, such as for storage, processing, display or the like, is depicted in FIG. 2. The apparatus 16 may be employed, for example, in conjunction with the user device 10 of FIG. 1 and may be embodied in a mobile terminal 30, such as shown in FIG. 3 and described below. However, it should be noted that the apparatus 16 of FIG. 2 may also be employed in connection with a variety of other devices, both mobile and fixed, and therefore, embodiments of the present invention should not be limited to application on devices such as the mobile terminal 30 of FIG. 3. For example, the apparatus 16 may be employed on a personal computer or other user terminal.

It should also be noted that while FIG. 2 illustrates one example of a configuration of an apparatus 16 for receiving and parsing sensor data, numerous other configurations may also be used to implement embodiments of the present invention. As such, in some embodiments, although devices or elements are shown as being in communication with each other, hereinafter such devices or elements should be considered to be capable of being embodied within a same device or element and thus, devices or elements shown in communication should be understood to alternatively be portions of the same device or element.

Referring now to FIG. 2, the apparatus 16 for receiving and parsing sensor data may include or otherwise be in communication with a processor 20, a communication interface 22 and a memory device 24. As described below and as indicated by the dashed lines in FIG. 2, the apparatus 16 may also optionally include a user interface 26 in some embodiments, such as embodiments in which the apparatus 16 is embodied as a user device 10. In some embodiments, the processor 20 (and/or co-processors or any other processing circuitry assisting or otherwise associated with the processor) may be in communication with the memory device 24 via a bus for passing information among components of the apparatus 16. The memory device 24 may include, for example, one or more volatile and/or non-volatile memories. In other words, for example, the memory device 24 may be an electronic storage device (e.g., a computer readable storage medium) comprising gates configured to store data (e.g., bits) that may be retrievable by a machine (e.g., a computing device like the processor 20). The memory device 24 may be configured to store information, data, content, applications, instructions, or the like for enabling the apparatus to carry out various functions in accordance with an example embodiment of the present invention. For example, the memory device 24 could be configured to buffer input data for processing by the processor 20. Additionally or alternatively, the memory device 24 could be configured to store instructions for execution by the processor 20.

The apparatus 16 may, in some embodiments, be a user terminal (e.g., mobile terminal 30) or a fixed communication device or computing device configured to employ an example embodiment of the present invention. However, in some embodiments, the apparatus 16 may be embodied as a chip or chip set. In other words, the apparatus 16 may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus 16 may therefore, in some cases, be configured to implement an embodiment of the present invention on a single chip or as a single “system on a chip.” As such, in some cases, a chip or chipset may constitute means for performing one or more operations for providing the functionalities described herein.

The processor 20 may be embodied in a number of different ways. For example, the processor 20 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor 20 may include one or more processing cores configured to perform independently. A multi-core processor may enable multiprocessing within a single physical package. Additionally or alternatively, the processor 20 may include one or more processors configured in tandem via the bus to enable independent execution of instructions, pipelining and/or multithreading.

In an example embodiment, the processor 20 may be configured to execute instructions stored in the memory device 24 or otherwise accessible to the processor 20. Alternatively or additionally, the processor 20 may be configured to execute hard coded functionality. As such, whether configured by hardware or software methods, or by a combination thereof, the processor 20 may represent an entity (e.g., physically embodied in circuitry) capable of performing operations according to an embodiment of the present invention while configured accordingly. Thus, for example, when the processor 20 is embodied as an ASIC, FPGA or the like, the processor 20 may be specifically configured hardware for conducting the operations described herein. Alternatively, as another example, when the processor 20 is embodied as an executor of software instructions, the instructions may specifically configure the processor 20 to perform the algorithms and/or operations described herein when the instructions are executed. However, in some cases, the processor 20 may be a processor of a specific device (e.g., a mobile terminal) configured to employ an embodiment of the present invention by further configuration of the processor 20 by instructions for performing the algorithms and/or operations described herein. The processor 20 may include, among other things, a clock, an arithmetic logic unit (ALU) and logic gates configured to support operation of the processor.

Meanwhile, the communication interface 22 may be any means such as a device or circuitry embodied in either hardware or a combination of hardware and software that is configured to receive and/or transmit data from/to a network 14 and/or any other device or module in communication with the apparatus 16. In this regard, the communication interface 22 may include, for example, an antenna (or multiple antennas) and supporting hardware and/or software for enabling communications with a wireless communication network. Additionally or alternatively, the communication interface 22 may include the circuitry for interacting with the antenna(s) to cause transmission of signals via the antenna(s) or to handle receipt of signals received via the antenna(s). In some environments, the communication interface 22 may alternatively or also support wired communication. As such, for example, the communication interface 22 may include a communication modem and/or other hardware/software for supporting communication via cable, digital subscriber line (DSL), universal serial bus (USB) or other mechanisms.

In some embodiments, such as instances in which the apparatus 16 is embodied by a user device 10, the apparatus may include a user interface 26 that may, in turn, be in communication with the processor 20 to receive an indication of a user input and/or to cause provision of an audible, visual, mechanical or other output to the user. As such, the user interface 26 may include, for example, a keyboard, a mouse, a joystick, a display, a touch screen(s), touch areas, soft keys, a microphone, a speaker, or other input/output mechanisms. Alternatively or additionally, the processor 20 may comprise user interface circuitry configured to control at least some functions of one or more user interface elements such as, for example, a speaker, ringer, microphone, display, and/or the like. The processor 20 and/or user interface circuitry comprising the processor may be configured to control one or more functions of one or more user interface elements through computer program instructions (e.g., software and/or firmware) stored on a memory accessible to the processor (e.g., memory device 24, and/or the like). In other embodiments, however, the apparatus 16 may not include a user interface 26.

Turning now to FIG. 3, a block diagram of a mobile terminal 30 that may embody the apparatus 16 of FIG. 2 and that would benefit from embodiments of the present invention is illustrated. It should be understood, however, that the mobile terminal 30 as illustrated and hereinafter described is merely illustrative of one type of user device that may benefit from embodiments of the present invention and, therefore, should not be taken to limit the scope of embodiments of the present invention. As such, although numerous types of mobile terminals, such as portable digital assistants (PDAs), mobile telephones, pagers, mobile televisions, gaming devices, laptop computers, cameras, tablet computers, touch surfaces, wearable devices, video recorders, audio/video players, radios, electronic books, positioning devices (e.g., global positioning system (GPS) devices), or any combination of the aforementioned, and other types of voice and text communications systems, may readily employ embodiments of the present invention, other user devices including fixed (non-mobile) electronic devices may also employ some example embodiments.

The mobile terminal 30 may include an antenna 32 (or multiple antennas) in operable communication with a transmitter 34 and a receiver 36 with the combination thereof comprising the communication interface 22 of the apparatus 16 of FIG. 2 in one embodiment. The mobile terminal 30 may further include an apparatus, such as a processor 38 or other processing device (e.g., processor 20 of the apparatus 16 of FIG. 2), which controls the provision of signals to and the receipt of signals from the transmitter 34 and receiver 36, respectively. The signals may include signaling information in accordance with the air interface standard of the applicable cellular system, and also user speech, received data and/or user generated data. In this regard, the mobile terminal 30 is capable of operating with one or more air interface standards, communication protocols, modulation types, and access types. By way of illustration, the mobile terminal 30 is capable of operating in accordance with any of a number of first, second, third and/or fourth-generation communication protocols or the like. For example, the mobile terminal 30 may be capable of operating in accordance with second-generation (2G) wireless communication protocols IS-136 (time division multiple access (TDMA)), GSM (global system for mobile communication), and IS-95 (code division multiple access (CDMA)), or with third-generation (3G) wireless communication protocols, such as Universal Mobile Telecommunications System (UMTS), CDMA2000, wideband CDMA (WCDMA) and time division-synchronous CDMA (TD-SCDMA), with 3.9G wireless communication protocol such as evolved UMTS Terrestrial Radio Access Network (E-UTRAN), with fourth-generation (4G) wireless communication protocols (e.g., Long Term Evolution (LTE) or LTE-Advanced (LTE-A) or the like. As an alternative (or additionally), the mobile terminal 30 may be capable of operating in accordance with non-cellular communication mechanisms. For example, the mobile terminal 30 may be capable of communication in a wireless local area network (WLAN) or other communication networks.

In some embodiments, the processor 38 may include circuitry desirable for implementing audio and logic functions of the mobile terminal 30. For example, the processor 38 may be comprised of a digital signal processor device, a microprocessor device, and various analog to digital converters, digital to analog converters, and other support circuits. Control and signal processing functions of the mobile terminal 30 are allocated between these devices according to their respective capabilities. The processor 38 thus may also include the functionality to convolutionally encode and interleave message and data prior to modulation and transmission. The processor 38 may additionally include an internal voice coder, and may include an internal data modem. Further, the processor 38 may include functionality to operate one or more software programs, which may be stored in memory. For example, the processor 38 may be capable of operating a connectivity program, such as a conventional Web browser. The connectivity program may then allow the mobile terminal 30 to transmit and receive Web content, such as location-based content and/or other web page content, according to a Wireless Application Protocol (WAP), Hypertext Transfer Protocol (HTTP) and/or the like, for example.

The mobile terminal 30 may also comprise a user interface, such as user interface 26 of the apparatus 16 of FIG. 2, including an output device such as a conventional earphone or speaker 42, a ringer 40, a microphone 44, a display 46, and a user input interface, all of which are coupled to the processor 38. The user input interface, which allows the mobile terminal 30 to receive data, may include any of a number of devices allowing the mobile terminal to receive data, such as a keypad 48, a touch screen display (display 46 providing an example of such a touch screen display) or other input device. In embodiments including the keypad 48, the keypad may include the conventional numeric (0-9) and related keys (#, *), and other hard and soft keys used for operating the mobile terminal 30. Alternatively or additionally, the keypad 48 may include a conventional QWERTY keypad arrangement. The keypad 48 may also include various soft keys with associated functions. In addition, or alternatively, the mobile terminal 30 may include an interface device such as a joystick or other user input interface. Some embodiments employing a touch screen display, as described further below, may omit the keypad 48 and any or all of the speaker 42, ringer 40 and microphone 44 entirely. The mobile terminal 30 further includes a battery, such as a vibrating battery pack, for powering various circuits that are required to operate the mobile terminal, as well as optionally providing mechanical vibration as a detectable output.

The mobile terminal 30 may further include a user identity module (UIM) 50. The UIM 50 is typically a memory device having a processor built in. The UIM 50 may include, for example, a subscriber identity module (SIM), a universal integrated circuit card (UICC), a universal subscriber identity module (USIM), a removable user identity module (R-UIM), a virtual user identity module, etc. The UIM 50 typically stores information elements related to a mobile subscriber. In addition to the UIM 50, the mobile terminal 30 may be equipped with memory. For example, the mobile terminal 30 may include volatile memory 52, such as volatile random access memory (RAM) including a cache area for the temporary storage of data. The mobile terminal 30 may also include other non-volatile memory 56, which may be embedded and/or may be removable. The memories may store any of a number of pieces of information, and data, used by the mobile terminal 30 to implement the functions of the mobile terminal. For example, the volatile memory 52 and/or the non-volatile memory 56 may comprise the memory device 24 of the apparatus 16 of FIG. 2.

As shown in FIG. 3, the mobile terminal 30 may also include one or more means for sharing and/or obtaining data. For example, the mobile terminal may comprise a short-range radio frequency (RF) transceiver and/or interrogator 56 so data may be shared with and/or obtained from electronic devices in accordance with RF techniques. The mobile terminal may comprise other short-range transceivers, such as, for example, a Bluetooth™ (BT) transceiver 58 operating using Bluetooth™ brand wireless technology developed by the Bluetooth™ Special Interest Group, an infrared (IR) transceiver, a wireless universal serial bus (USB) transceiver and/or the like. The Bluetooth™ transceiver 58 may be capable of operating according to ultra-low power Bluetooth™ technology (e.g., Wibree™) radio standards. In this regard, the mobile terminal 30 and, in particular, the short-range transceiver may be capable of transmitting data to and/or receiving data from electronic devices, such as sensors 12, within a proximity of the mobile terminal, such as within 10 meters, for example. Although not shown, the mobile terminal 30 may be capable of transmitting and/or receiving data from electronic devices, such as sensors 12, according to various wireless networking techniques, including Wi-Fi, WLAN techniques such as IEEE 802.11 techniques, IEEE 802.15 techniques, IEEE 802.16 techniques, and/or the like.

As shown in FIG. 1, a sensor 12 may be configured to transmit a message, such as a measurement report including data collected by the sensor, via a network 14. In this regard, the sensor 12 may be configured to transmit the measurement report on a periodic basis, in response to the collection of additional data or in response to the occurrence of another triggering event. The sensor 12 may be configured to multicast the message, such as a measurement report, via the network 14 such that the message may be received by a plurality of devices including, for example, the user device 10, that are in communication with the network.

The message provided by the sensor 12 includes an application identifier that identifies one or more applications that are configured to parse an otherwise process the data provided by the sensor. The application identifier may have a variety of different formats and may, in one embodiment, be a binary number, such as having 32 bits, 64 bits, 128 bits, or any other length. Alternatively, the application identifier may be a name, a uniform resource indicator (URI) or the like that identifies the respective application.

The message including the application identifier may be provided by the sensor 12 in a variety of different types, such as an IP packet. For example, the sensor 12 may be configured to transmit and the user device 10 may be configured to receive a constrained application protocol (CoAP) message that is transmitted utilizing universal data protocol (UDP) to a multicast address so as to be directed to all devices on the network 14 or directly to a gateway or other device, such as a control point, in an instance in which the sensor has learned the address of the user device. In an embodiment using a CoAP message, the application identifier may be positioned within the hypertext transport protocol (HTTP)/extended markup language (XML) message, such as <appid>value</appid> in which the application identifier is represented by “value”.

Alternatively, in an instance in which the sensor 12 is an IPv6 sensor, the sensor may be configured to transmit, either via multicast or directly to a gateway, control point or user device 10, an IPv6 packet that includes an IPv6 destination object including the application identifier. In instances in which there will be no more than the 2³² different applications, a destination option included within an IPv6 packet may be defined as follows:

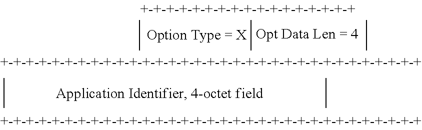

However, in instances in which there are potentially more applications to be identified, the destination option field may be larger.

In yet another embodiment, the sensor 12 may include the message including the application identifier in a universal plug and play (UPnP) multicast event, such as utilizing simple service discovery protocol (SSDP) and expressed in XML. In an embodiment in which the sensor 12 is capable of unidirectional communications, such as being capable of transmitting, but not receiving messages, the UPnP control point, such as the user device 10, may receive the UPnP multicast event, but will not be able to request data or the like from the sensor. In this regard, a sensor 12 may transmit a discovery message including an application identifier in the form of, for example, a uniform resource locator (URL).

In the foregoing embodiments, the multicast address utilized by the sensor 12 may be dynamic. Alternatively, the multicast address may be reserved globally, such as by the internet assigned numbers authority (IANA), for sensor output or reserved for proprietary usage.

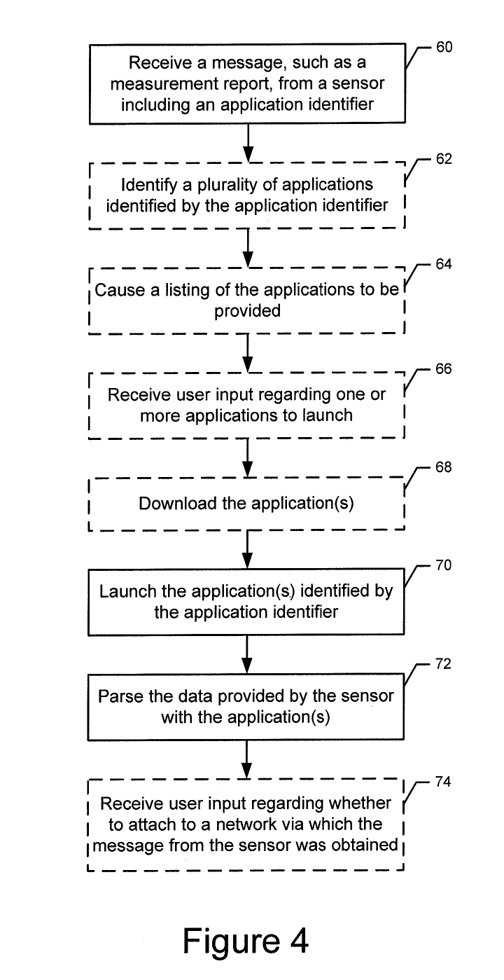

As shown in operation 60 of FIG. 4, the apparatus 16, such as may be embodied by a mobile terminal 30, may be configured to receive the message, such as a measurement report, from the sensor 12 that may include or otherwise be associated with the application identifier. As such, the apparatus 16 may include means, such as the communications interface 22, the processor 20 or the like, for receiving the message, such as the measurement report, including the application identifier. In the embodiment of FIG. 3 in which the apparatus 16 is embodied as a mobile terminal 30, the mobile terminal may include means, such as an antenna 32, a receiver 36, a processor 38 or the like, for receiving the message, such as the measurement report, including the application identifier.

As described above, the message, such as a measurement report, including the application identifier may be a multicast message that is received by the user device 10, such as a mobile terminal 30, in communication with a network 14. Alternatively, the message including the application identifier may be specifically addressed to the user device 10, such as a mobile terminal 30, and transmitted via the network 14 or directly to the user device, such as via a RF transceiver 56 or a BT transceiver 58, for example.

As shown in operation 70 of FIG. 4, the apparatus 16, such as may be embodied by a mobile terminal 30, may also be configured to launch one or more applications identified by the application identifier. Thus, in an instance in which the application identified by the application identifier is not already installed and executing, the apparatus 16, such as the processor 20, may recognize the application identifier, such as comparing the application identifier to a predefined listing of application identifiers and associated applications. Alternatively, the apparatus 16 may query another entity, such as an application store or other repository of applications, so as to identify the application associated with the application identifier. Once the application has been recognized by the apparatus 16 based upon the application identifier, the apparatus, such as the processor 20, may cause the application to be launched, thereby commencing execution of the application. As such, the apparatus 16 may include means, such as the processor 20 or the like, for launching one or more applications identified by the application identifier. Similarly, in an embodiment in which the apparatus 16 is embodied as a mobile terminal 30, the mobile terminal may include means, such as the processor 38 or the like, for launching one or more applications identified by the application identifier.

Once the application identified by the application identifier has been launched, the data provided by the sensor 12 via a measurement report may be parsed by the application as shown in operation 72 of FIG. 4 and may then be stored, processed, communicated, displayed or the like by apparatus 16. For example, in instances in which the sensor 12 is a camera, such as a CCD camera, the application identified by the application identifier may be a dash board application that may permit the images captured by the camera to be viewed, stored, played back or the like. As another example, in an instance in which the sensor 12 is a heart rate sensor, the application identified by the application identifier may be a sports tracker application so as to collect and display the sensed data. Thus, the apparatus 16 may include means, such as the processor 20 or the like, for parsing the data provided by the sensor 12 with the application identified by the application identifier. For example, in an embodiment in which the apparatus 16 is embodied as a mobile terminal 30, the mobile terminal may include means, such as the processor 38 or the like, for parsing the data provided by the sensor 12 with the application identified by the application identifier.

In some embodiments, certain ones of the operations above may be modified or further amplified as described below. Moreover, in some embodiments additional optional operations may also be included (some examples of which are shown in dashed lines in FIG. 4). It should be appreciated that each of the modifications, optional additions or amplifications below may be included with the operations above either alone or in combination with any others among the features described herein. In an example embodiment in which the application identified by the application identifier is not already installed on the apparatus 16, such as in the memory device 24, the apparatus, such as a mobile terminal 30 in one embodiment, may be configured to download the application identified by the application identifier. See operation 68 of FIG. 4. In this regard, the application identifier may not only identify the application, but may identify the source of the application from which the application may be downloaded, such as a store, a repository or the like, such as by including the URL of the source of the application within the message. Alternatively, the apparatus 16 may be configured in advance with the identity, such as the address, of the source of the application. For example, the memory device 24 may include the identity of the source of the applications, either generally for all applications or individually on a per application basis. As such, the apparatus 16 may include means, such as the communication interface 22, the processor 20 or the like, for downloading the application identified by the application identifier. For example, in the embodiment in which the apparatus 16 comprises a mobile terminal 30, the mobile terminal may include means, such as the antenna 32, the receiver 36, the processor 38 or the like, for downloading the application identified by the application identifier. While the application is being downloaded, the message may be queued and may then be passed to the application upon its launch for execution.

In one embodiment, the application identified by the application identifier is not simply downloaded, but is purchased from a source, such as an application store, a store operated by the vendor of the mobile terminal 30 or the like. As such, the apparatus 16, such as the processor 20, may be configured interact with the source of the application in order to arrange for the purchase of the application and the subsequent download of the application. In an embodiment in which the apparatus 16 is included within a mobile terminal 20, the mobile terminal may include means, such as the processor 38 or the like, for purchasing the application.

Prior to downloading and/or prior to purchasing the application identified by the application identifier, the apparatus 16 may include means, such as the processor 20, the user interface 26 or the like, for causing a message to be displayed or otherwise provided to the user that is indicative of the application that is to be downloaded, purchased or the like in order to parse the sensor data. Based upon this message, the user may provide input, such as via the user interface 26, that authorizes the download, the purchase or the like, or that terminates efforts to download or purchaser the application. In instances where the user authorizes the purchase or download of the application, the application may then be downloaded or purchased as described above.

In one embodiment, the application identifier may identify a plurality of applications that may be utilized either alternatively or in combination to parse the data provided by the sensor 12. As such, the apparatus 16 may include means, such as the processor 20 or the like, for identifying a plurality of applications identified by the application identifier, such as based upon the predetermined associations between the application identifier and one or more applications. See operation 62 of FIG. 4. Similarly, in an embodiment in which the apparatus 16 is embodied by a mobile terminal 30, the mobile terminal may include means, such as a processor 38 or the like, for identifying a plurality of applications identified by the application identifier. In one embodiment in which a plurality of applications are identified by the application identifier, the apparatus 16, such as a mobile terminal 30, may cause a listing of the applications to be provided to a user, such as by listing the plurality of applications upon a display 46. See operation 64. As such, the apparatus 16 may include means, such as a processor 20, the user interface 26 or the like, for causing a listing of the applications to be provided. Similarly, in an embodiment in which the apparatus 16 is embodied by a mobile terminal 30, the mobile terminal may include means, such as a processor 38, a display 46 or the like, for causing the listing of the applications to be provided for the user.

In response for the listing of applications that were identified by the application identifier, user input may be received regarding one or more of the listed applications that are to be launched and, in an embodiment in which the applications are not already stored by the apparatus 16, identifying one or more applications to be purchased and/or downloaded. See operations 66 and 68 of FIG. 4. As such, the apparatus 16 may include means, such as the processor 20, the user interface 26 or the like, for receiving user input regarding the application(s) to launch. Similarly, in an embodiment to which the apparatus 16 is embodied by a mobile terminal 30, the mobile terminal may include means, such as the display 46, the keyboard 48, the processor 38 or the like, for receiving the user input regarding one or more of the listed applications to launch. Thereafter, the apparatus 16 may download, such as by purchasing, if necessary, the application(s) selected by the user and may then launch the application(s) in order to subsequently parse the data provided by the sensor 12.

As described above, the user device 10 and the sensor 12 may be in communication via a network 14. After having initially communicated with the sensor 12, the user device 10 may determine whether the user device should attach to the network 14 whenever possible. While the user device 10 may unilaterally determine whether to access the network 14 whenever possible, a device in communication with the network may cause an inquiry to be transmitted to the user device inquiring as to whether the user device is to access the network whenever possible. In one embodiment in which the user device 10 includes an apparatus 16 as shown in FIG. 2, the apparatus may query the user, such as via the user interface 26, as to whether the user desires for the apparatus to be attached the network 14 whenever possible. As such, the apparatus may receive user input regarding whether to attach to the network 14 and may then proceed accordingly, such as by either attaching to the network whenever possible or not, depending upon the user input. As such, the apparatus 16 of this embodiment may include means, such as the processor 20, the user interface 26 or the like, for receiving user input regarding whether to attach to the network 14 whenever possible. For example, in the embodiment in which the apparatus 16 is embodied by a mobile terminal 30, the mobile terminal may include means, such as the display 46, the keypad 48, the processor 38 or the like, for receiving user input regarding whether to attach to the network 14 whenever possible.

The apparatus 16, method and computer program product of an example embodiment may be employed in conjunction with a wide variety of sensors 12 that communicate via various networks 14 with a user device 10, such as a mobile terminal 30. By way of example, but not of limitation, several example embodiments will now be described. In one instance the sensor 12 may be connected to a home local network (LAN) such as via Wi-Fi, an RJ-45 port to a physical Ethernet or the like. The home LAN may, in turn, be connected to the internet. Upon the collection of data, the sensor 12 may multicast the message, such as a measurement report, including the application identifier via the home LAN. In this embodiment, a user device 10 is in communication with the home LAN so as to receive the multicast message from the sensor 12 including the application identifier. The user device 10 may identify the application that corresponds to the application identifier and may determine that the application is not stored or otherwise installed upon the user device. As such, the user device may download, and in some instances, purchase and download the application designated by the application identifier. Upon installation and execution of the application, the application may parse the data provided by the sensor 12 and then may provide the data to the user.

As another example, a mobile terminal 30 may establish communications with a near field communication (NFC) tag, such as an NFC tag, proximate the entrance of a hotel room. The mobile terminal 30 may establish communications in various manners, but, in one embodiment, may be associated with the tag by tapping the tag. Once communications have been established, the NFC tag may provide a message that includes an application identifier, such as in the form of an IPv6 packet. The mobile terminal 30 may then launch the application designated by the application identifier if the application was previously installed or may download, such as by first purchasing and then downloading, the application designated by the application identifier in an instance in which the application was not previously installed. Once installed and launched, the mobile terminal may be configured to parse data provided by various sensors in its proximity. In the example in which the NFC tag is located proximate a hotel room, the application downloaded by the mobile terminal 30 may be configured to cause the mobile terminal to listen for sensors 12 within a local area network. The mobile terminal 30 may be able to communicate with these other sensors 12 by parsing the data provided by the sensors and, in turn, by issuing messages configured to control various equipment in the hotel room, such as the television, the air conditioner, WLAN settings, etc.

As yet another embodiment, a home LAN may include a router, such as a home gateway, that is configured to multicast router advertisements that include an application identifier. As such, the sensor 12 may be embodied by the router in this embodiment. A user device 10 may also be connected to the LAN and may receive the multicast message from the home gateway. This message may include the application identifier that may direct the user device to an applications store or other source, such as the home gateway itself, in order to download the application designated by the application identifier. Following downloading, installation and launch of the application, the application is able to parse the data provided by the measurement reports so as to permit the mobile terminal to control, tune or monitor the home gateway via the respective application.

By identifying one or more applications that are configured to parse the data provided by a sensor 12, an apparatus 16, such as may be embodied by a mobile terminal 30, may purchase and/or download the applications if necessary prior to launching the applications in order to parse the data provided by the sensor with little, if any, user input. Thus, the method, apparatus and computer program product of an example embodiment may facilitate the communication of data between an apparatus 16, such as may be embodied by a mobile terminal 30, and one or more sensors 12 in order to improve the user experience through provision of the sensor data without requiring extensive user involvement in the configuration of the system.

FIG. 4 illustrates a flowchart of a system, method, and computer program product according to an example embodiment. It will be understood that each block of the flowchart, and combinations of blocks in the flowchart, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by one or more memory devices of an apparatus, such as a mobile terminal (for example, in the memory device 24 of the apparatus 16 of FIG. 2 or the volatile or non-volatile memory 52, 54 of the mobile terminal 30 of FIG. 3) and executed by a processor (for example, by the processor 20 of the apparatus 16 of FIG. 2 or the processor 38 of the mobile terminal 30 of FIG. 3). In some embodiments, the computer program instructions comprising the computer program product(s) which embody the procedures described above may be stored by memory devices of a plurality of computing devices. As will be appreciated, any such computer program product may be loaded onto a computer or other programmable apparatus (for example, an apparatus 16) to produce a machine, such that the computer program product including the instructions which execute on the computer or other programmable apparatus creates means for implementing the functions specified in the flowchart block(s). Further, the computer program product may comprise one or more computer-readable memories on which the computer program instructions may be stored such that the one or more computer-readable memories can direct a computer or other programmable apparatus to function in a particular manner, such that the computer program product comprises an article of manufacture which implements the function specified in the flowchart block(s). The computer program instructions of one or more computer program products may also be loaded onto a computer or other programmable apparatus (for example, an apparatus 16) to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions. It will also be understood that one or more blocks of the flowchart, and combinations of blocks in the flowchart, may be implemented by special purpose hardware-based computer systems which perform the specified functions, or combinations of special purpose hardware and computer program product(s).

The above described functions may be carried out in many ways. As described above, for example, any suitable means for carrying out each of the functions described above may be employed to carry out embodiments of the invention. In one embodiment, a suitably configured processor (for example, the processor 20) may provide all or a portion of the elements. In another embodiment, all or a portion of the elements may be configured by and operate under control of a computer program product. The computer program product for performing the methods of an example embodiment of the invention includes a computer-readable storage medium (for example, the memory device 24), such as the non-volatile storage medium, and computer-readable program code portions, such as a series of computer instructions, embodied in the computer-readable storage medium.

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1-23. (canceled)

24. A method comprising:
receiving a message provided by a sensor, wherein the message includes an application identifier;
launching an application identified by the application identifier; and
parsing data provided by the sensor with the application.

25. A method according to claim 24 further comprising downloading the application identified by the application identifier following receipt of the message.

26. A method according to claim 25 wherein downloading the application comprises purchasing the application.

27. A method according to claim 25 further comprising causing a notification to be provided regarding the application identified by the application prior to downloading the application.

28. A method according claim 24 further comprising identifying a plurality of applications identified by the application identifier and causing a listing of the plurality of applications to be provided in order to solicit user input regarding one or more of the plurality of applications to be launched.

29. A method according to claim 24 wherein receiving the message comprises receiving a measurement report including the data from the sensor.

30. A method according to claim 24 wherein receiving the message comprises receive a universal plug and play (UPnP) multicast event including the application identifier.

31. An apparatus comprising at least one processor and at least one memory storing computer program code, wherein the at least one memory and stored computer program code are configured, with the at least one processor, to cause the apparatus to at least:
receive a message provided by a sensor, wherein the message includes an application identifier;
launch an application identified by the application identifier; and
parse data provided by the sensor with the application.

32. An apparatus according to claim 31 wherein the at least one memory and stored computer program code are further configured, with the at least one processor, to cause the apparatus to download the application identified by the application identifier following receipt of the message.

33. An apparatus according to claim 32 wherein the at least one memory and stored computer program code are configured, with the at least one processor, to cause the apparatus to download the application by purchasing the application.

34. An apparatus according to claim 32 wherein the at least one memory and stored computer program code are further configured, with the at least one processor, to cause the apparatus to cause a notification to be provided regarding the application identified by the application prior to downloading the application.

35. An apparatus according to claim 31 wherein the at least one memory and stored computer program code are further configured, with the at least one processor, to cause the apparatus to identify a plurality of applications identified by the application identifier and to cause a listing of the plurality of applications to be provided in order to solicit user input regarding one or more of the plurality of applications to be launched.

36. An apparatus according to claim 31 wherein the message comprises a measurement report including the data from the sensor.

37. An apparatus according to claim 31 wherein the at least one memory and stored computer program code are configured, with the at least one processor, to cause the apparatus to receive the message by receiving a universal plug and play (UPnP) multicast event including the application identifier.

38. An apparatus according to claim 31, wherein the apparatus comprises or is embodied in a mobile terminal.

39. An apparatus according to claim 38, wherein the mobile terminal comprises user interface circuitry and user interface software stored on one or more of the at least one memory; wherein the user interface circuitry and user interface software are configured to:
facilitate user control of at least some functions of the mobile terminal through use of a display; and
cause at least a portion of a user interface of the mobile terminal to be displayed on the display to facilitate user control of at least some functions of the mobile terminal.

40. A computer program product comprising at least one non-transitory computer-readable storage medium having computer-readable program instructions stored therein, the computer-readable program instructions comprising:
program instructions configured to receive a message provided by a sensor, wherein the message includes an application identifier;
program instructions configured to launch an application identified by the application identifier; and
program instructions configured to parse data provided by the sensor with the application.

41. A computer program product according to claim 40 wherein the computer-readable program instructions further comprise program instructions configured to download the application identified by the application identifier following receipt of the message.

42. A computer program product according to claim 41 wherein the computer-readable program instructions configured to download the application comprise computer-readable program instructions configured to purchase of the application.

43. A computer program product according to claim 41 wherein the computer-readable program instructions further comprise program instructions configured to cause a notification to be provided regarding the application identified by the application prior to downloading the application.
